(19) United States
(12) Patent Application Publication
(10) Pub. No.: US 2012/0163510 A1
(43) Pub. Date: Jun. 28, 2012

(54) WIRELESS COMMUNICATION DEVICES AND METHODS

(75) Inventors: Woong CHO, Daejeon (KR); Hak-Lim KO, Chungcheongnam-do (KR)

(73) Assignees: INDUSTRY ACADEMIC COOPERATION FOUNDATION OF HOSEO UNIVERSITY, Chungcheongnam-do (KR); ELECTRONICS AND TELECOMMUNICATIONS RESEARCH INSTITUTE, Daejeon (KR)

(21) Appl. No.: 13/334,588

(22) Filed: Dec. 22, 2011

(30) Foreign Application Priority Data
Dec. 22, 2010 (KR) 10-2010-0132274

(51) Int. Cl. H04L 27/06; H04L 27/00

(52) U.S. Cl. 375/340; 375/316

(57) ABSTRACT

Provided are wireless communication methods. The wireless communication method receives communication information through a plurality of antennas, generates a plurality of beam directions, selects one of the beam directions on the basis of the received communication information, and performs communication using the selected beam direction. Communication information received through the unselected beam directions among the beam directions are ignored.

### CROSS-REFERENCE TO RELATED APPLICATIONS

This U.S. non-provisional patent application claims priority under 35 U.S.C. §119 of Korean Patent Application No. 10-2010-0132274, filed on Dec. 22, 2010, the entire contents of which are hereby incorporated by reference.

### BACKGROUND OF THE INVENTION

The present invention disclosed herein relates to communication, and more particularly, to wireless communication devices and methods.

Wireless communication devices perform communication over a wireless network. The wireless network includes an infrastructured network and an infrastructureless network. The infrastructured network denotes a network based on infrastructures which are fixed and wirelessly connected, as in a base station or an Access Point (AP). In infrastructured wireless network, wireless communication devices are connected to the wireless network through communication with a base station or an access point.

The Infrastructureless network denotes a network that is not based on infrastructures such as base stations or access points but based on wireless mobile terminals. In infrastructureless wireless network, communication devices configure the wireless network through communication therebetween. An ad hoc network is a type of infrastructureless network. The ad hoc network has an autonomous structure in which communication-enabled communication devices configure a network through mutual communications.

### SUMMARY OF THE INVENTION

The present invention provides communication devices and methods having enhanced reliability and frequency reuse rate.

Embodiments of the present invention provide a wireless communication method including: receiving communication information through a plurality of antennas; generating a plurality of beam directions; selecting one of the beam directions on the basis of the received communication information; and performing communication using the selected beam direction, wherein communication information received through the unselected beam directions among the beam directions are ignored.

In some embodiments, the selecting of one may include selecting a beam direction, where a highest power of the communication information is received, among the beam directions.

In other embodiments, the wireless communication method may further include selecting another beam direction from among the beam directions to perform communication in the other selected beam direction, when an error rate of data communicated in the selected beam direction becomes higher than a reference value.

In still other embodiments, a beam direction where a highest power of data is received may be selected from among the beam directions when the error rate of the data communicated in the selected beam direction becomes higher than the reference value.

In other embodiments of the present invention, a wireless communication method includes: a plurality of antennas; a plurality of beam formers connected to the antennas, respectively; a plurality of switches connected to the beam formers, respectively; a signal processing unit modulating and demodulating an output signal of one of the switches; and a beam direction selection unit controlling the switches for a first output signal, having a highest power among output signals of the beam formers, to be delivered to the signal processing unit, in a communication standby state, wherein the beam direction selection unit maintains a control state of each of the switches even when the output signals of the beam formers are changed, in a state where communication is being performed.

In some embodiments, the signal processing unit may demodulate the first output signal, determine a target address with the demodulated signal, and reset the beam direction selection unit to the communication standby state when the determined target address differs from an address of the communication device.

In other embodiments, the signal processing unit may demodulate the first output signal, determines a target address with the demodulated signal, and provide a beam direction fixing time information, indicating a time when the control states of the switches are maintained, to the beam direction selection unit when the determined target address is the same as an address of the communication device.

In still other embodiments, the signal processing unit may acquire or calculate expected communication time information from the communication information, and generate the beam direction fixing time information on the basis of the expected communication time information.

In even other embodiments, the signal processing unit may acquire or calculate expected communication time information from data to be transmitted, and generate the beam direction fixing time information on the basis of the expected communication time information.

In yet other embodiments, the beam direction selection unit may include: a plurality of band-pass filters connected to the beam formers, respectively; a plurality of amplifiers connected to the band-pass filters, respectively; a plurality of power detectors connected to the amplifiers, respectively; a comparator and selector generating a first signal which allows an output signal, having a highest power greater than a reference value, to be selected from among output signals of the power detectors; a counter performing counting during a time corresponding to the beam direction fixing time information, wherein the counter outputs a first logic value when the counting is performed, or outputs a second logic value when the counting is not performed; and a gate element outputting the same signal as the first signal when an output of the counter is the second logic value.

In further embodiments, when the output of the counter is the first logic value, the gate element may maintain a constant output signal despite a change in the first signal.

In still further embodiments, the beam direction selection unit may include: a plurality of band-pass filters connected to the beam formers, respectively; a plurality of amplifiers connected to the band-pass filters, respectively; a plurality of power detectors connected to the amplifiers, respectively; and a comparator and selector performing counting during a time corresponding to the beam direction fixing time information, wherein the comparator and selector outputs a signal which allows an output signal, having a highest power greater than a reference value, to be selected from among output signals of the power detectors when the counting is not performed.

In even further embodiments, when the counting is performed, the comparator and selector may maintain a constant output signal despite a change in the output signals of the power detectors.

In yet further embodiments, the signal processing unit may activate a control signal provided to the beam direction selection unit when communication is performed, and the signal processing unit may deactivate the control signal when communication is not performed.

In much further embodiments, the beam direction selection unit may include: a plurality of band-pass filters connected to the beam formers, respectively; a plurality of amplifiers connected to the band-pass filters, respectively; a plurality of power detectors connected to the amplifiers, respectively; and a comparator and selector outputting a signal which allows an output signal, having a highest power greater than a reference value, to be selected from among output signals of the power detectors when the control signal is deactivated.

In still much further embodiments, when the control signal is activated, the comparator and selector may maintain a constant output signal despite a change in the output signals of the power detectors.

In even much further embodiments, when an error rate of communicated data becomes higher than a reference value, the signal processing unit may control the beam direction selection unit for an output signal having a highest power to be reselected from among output signals of the beam formers.

In yet much further embodiments, when the reselected output signal does not correspond to a reception data, the signal processing unit may control the beam direction selection unit for the first output signal to be selected.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a communication device according to a first embodiment of the present invention;

FIG. 2 is a view illustrating an embodiment of an array antenna in FIG. 1;

FIG. 3 is a flowchart illustrating a communication method according to an embodiment of the present invention;

FIG. 4 is a block diagram illustrating a beam direction selection unit according to a first embodiment of the present invention;

FIG. 5 is a flowchart illustrating a communication method between first to fourth communication devices;

FIGS. 6 to 11 are views illustrating the first to fourth communication devices;

FIG. 12 is a block diagram illustrating a beam direction selection unit according to another embodiment of the present invention;

FIG. 13 is a block diagram illustrating a communication device according to a second embodiment of the present invention;

FIG. 14 is a block diagram illustrating a beam direction selection unit of FIG. 13;

FIG. 15 is a flowchart illustrating a method of changing a selected beam direction when first and second communication devices move; and

FIGS. 16 and 17 are views illustrating moving first and second communication devices.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

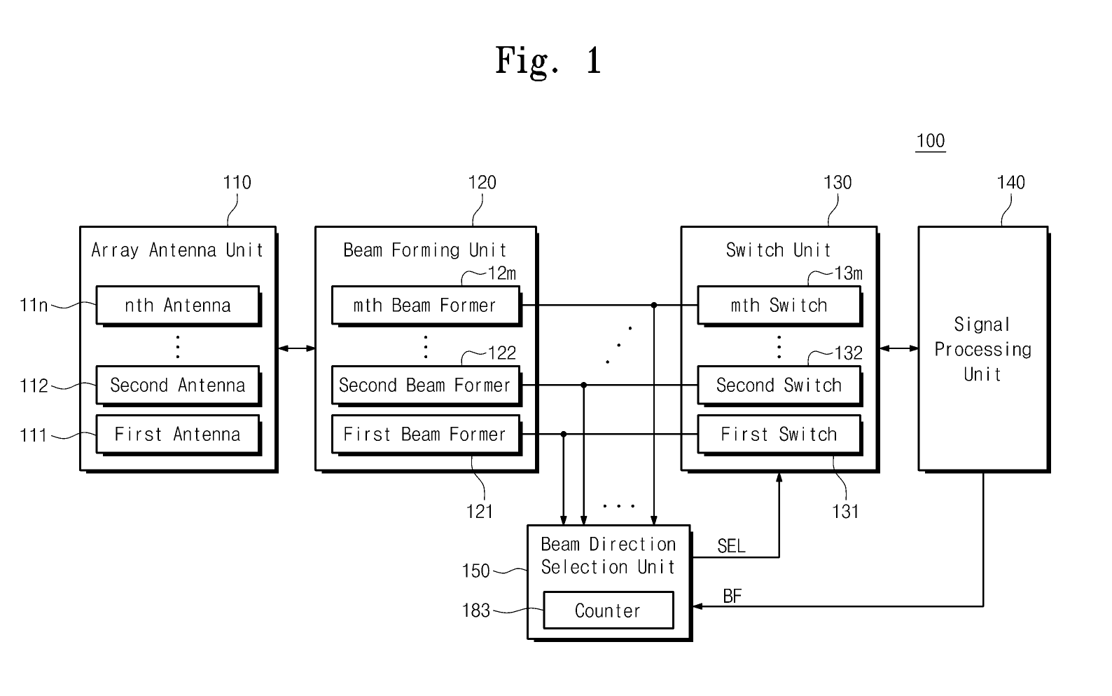

FIG. 1 is a block diagram illustrating a communication device 100 according to a first embodiment of the present invention.

Referring to FIG. 1, the communication device 100 includes an array antenna unit 110, a beam forming unit 120, a switch unit 130, a signal processing unit 140, and a beam direction selection unit 150.

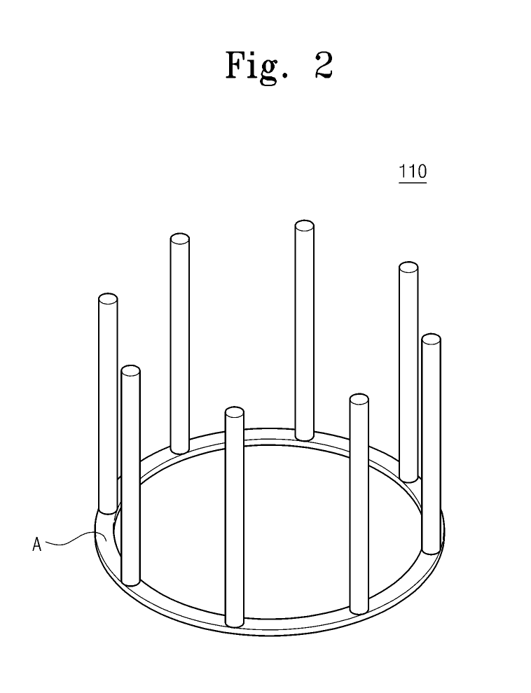

The array antenna unit 110 includes first to nth antennas 111 to 11n. For example, an embodiment of the array antenna unit 110 is illustrated in FIG. 2. Referring to FIG. 2, a plurality of antennas are arranged on a circular support A. However, the configuration of the array antenna unit 110 is not limited as illustrated in FIG. 2.

Referring back to FIG. 1, the beam forming unit 120 includes first to mth beam formers 121 to 121m which are connected to the first to nth antennas 111 to 11n, respectively. The first to mth beam formers 121 to 12m form beams, respectively. For example, the first beam former 121 forms a beam to transmit/receive a radio wave in a first direction. The second beam former 122 forms a beam to transmit/receive a radio wave in a second direction different from the first direction. The mth beam former 12m forms a beam to transmit/receive a radio wave in an mth direction different from the first and second directions. That is, directional communication may be performed in the first to mth directions with the beams formed by the first to mth beam formers 121 to 12m.

The switch unit 130 includes first to mth switches 131 to 13m which are connected to the first to mth beam formers 121 to 12m, respectively. The first to mth switches 131 to 13m deliver one of output signals of the first to mth beam formers 121 to 12m to the signal processing unit 140 in response to a selection signal SEL.

The signal processing unit 140 receives one of the output signals of the first to mth beam formers 121 to 12m through the switch unit 130. The signal processing unit 140 demodulates the received output signal. The signal processing unit 140 generates beam direction fixing time information BF according to the demodulated result. For example, when the demodulated signal is for the communication device 100, the signal processing unit 140 may generate the beam direction fixing time information BF. The signal processing unit 140 acquires/calculates expected communication time from the demodulated signal, and generates the beam direction fixing time information BF according to the acquired/calculated result. The beam direction fixing time information BF may be delivered to the beam direction selection unit 150.

The signal processing unit 140 modulates a transmission data. Based on the transmission data, the signal processing unit 140 generates the beam direction fixing time information BF. For example, the signal processing unit 140 may acquire/calculate the expected communication time from the transmission data, and generate the beam direction fixing time information BF according to the acquired/calculated result. The beam direction fixing time information BF may be delivered to the beam direction selection unit 150.

For example, the signal processing unit 140 may include a modem, a Medium Access Control (MAC), or the modem and the MAC.

The beam direction selection unit 150 receives the output signals of the first to mth beam formers 121 to 12m, and receives the beam direction fixing time information BF from the signal processing unit 140. Based on the output signals of the first to mth beam formers 121 to 12m and the beam direction fixing time information BF, the beam direction selection unit 150 generates the selection signal SEL. That is, one beam direction may be selected according to the selection signal SEL.

Exemplarily, the beam direction selection unit 150 may generate the selection signal SEL that allows an output signal having the highest power greater than a reference value to be selected from among the output signals of the first to mth beam formers 121 to 12m, in a communication standby state. In this case, the highest power greater than the reference value among the output signals of the first to mth beam formers 121 to 12m may be delivered to the signal processing unit 140 through the switch unit 130.

The beam direction selection unit 150 includes a counter 183. In the communication standby state, the counter 183 may be in a reset state. When the beam direction fixing time information BF is received, the counter 183 performs counting for a time corresponding to the beam direction fixing time information BF. While the counter 183 is performing counting, the beam direction selection unit 150 maintains the selection signal SEL even when the output signals of the first to mth beam formers 121 to 12m are changed.

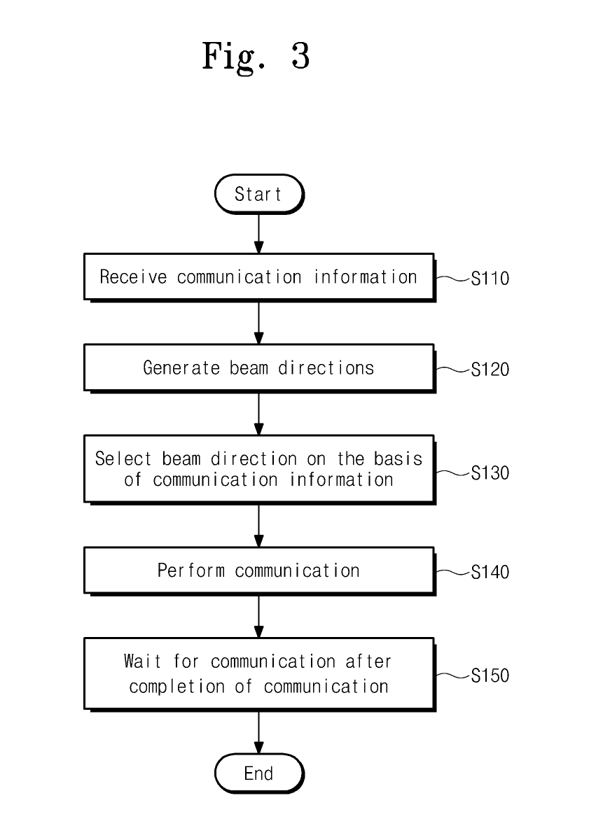

FIG. 3 is a flowchart illustrating a communication method according to an embodiment of the present invention.

Referring to FIGS. 1 and 3, communication information is received in operation S110. The communication information may be received through the array antenna 110. The communication information may include a Ready to Send (RTS) signal, a Clear to Send (CTS) signal, a beacon signal, a data packet, and a data frame that are received through the array antenna 110.

In operation S120, a plurality of beam directions are generated. For example, the first to mth beam formers 121 to 12m may generate the first to mth beam directions.

In operation S130, one beam direction is selected from among the generated beam directions according to the communication information. The beam direction selection unit 150 controls the selection signal SEL in order for a signal having the highest power greater than the reference value to be selected from among signals that are received through the first to nth antennas 111 to 11n and where beam formation has been performed in the first to mth beam directions. That is, a beam former that has received the highest power of the communication information may be selected from among the first to mth beam formers 121 to 12m.

In operation S140, communication is performed. While communication is being performed, output signals of unselected beam formers among the first to mth beam formers 121 to 12m may be ignored. Exemplarily, while communication is being performed, the beam direction selection unit 150 may maintain the selection signal SEL outputted even when the output signals of the first to mth beam formers 121 to 12m are changed.

In operation S150, communication is completed, and thereafter, the communication device 100 enters into the communication standby state. That is, the beam direction selection unit 150 controls the selection signal SEL in order for an output signal having the highest power greater than the reference value to be selected from among the output signals of the first to mth beam formers 121 to 12m.

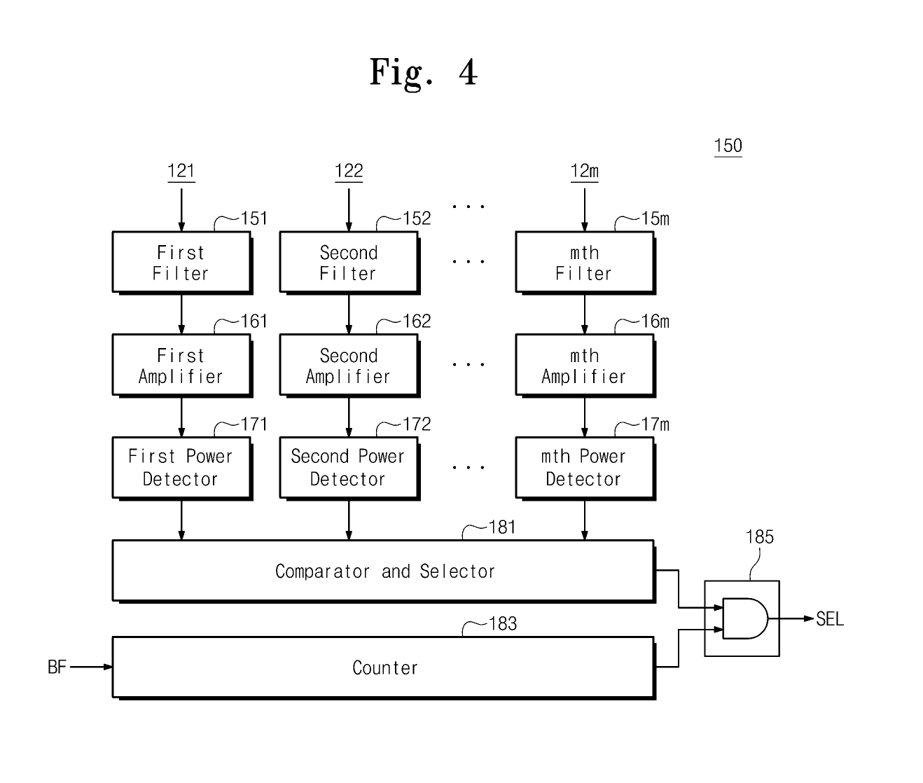

FIG. 4 is a block diagram illustrating the beam direction selection unit 150 according to a first embodiment of the present invention.

Referring to FIGS. 1 and 4, the beam direction selection unit 150 includes first to mth filters 151 to 15m, first to mth amplifiers 161 to 16m, first to mth power detectors 171 to 17m, a comparator and selector 181, a counter 183, and a gate element 185.

The first to mth filters 151 to 15m receive the output signals of the first to mth beam formers 121 to 12m. Each of the first to mth filters 151 to 15m may be a band-pass filter. The first to mth filters 151 to 15m may have a pass band corresponding to a bandwidth that is used in the communication device 100.

The first to mth amplifiers 161 to 16m receive and amplify signals filtered by the first to mth filters 151 to 15m, respectively.

The first to mth power detectors 171 to 17m receive signals amplified by the first to mth amplifiers 161 to 16m, respectively. The first to mth power detectors 171 to 17m detect powers of the amplified signals, respectively. Exemplarily, the first power detector 171 may output a signal corresponding to a power of the output signal of the first amplifier 161. The second power detector 172 may output a signal corresponding to a power of the output signal of the second amplifier 162. The mth power detector 17m may output a signal corresponding to a power of the output signal of the mth amplifier 16m.

The comparator and selector 181 compares the output signals of the first to mth power detectors 171 to 17m. The comparator and selector 181 generates a signal that allows an output signal having the highest power greater than the reference value to be selected from among the output signals of the first to mth power detectors 171 to 17m. For example, the reference value may be a communication-enabled minimum reception power.

The counter 183 receives the beam direction fixing time information BF from the signal processing unit 140. The counter 183 performs counting for a time corresponding to the received beam direction fixing time information BF. When counting is performed, the counter 183 may output a first logic value. When counting is not performed or the counter 183 is in a reset state, the counter 183 may output a second logic value different from the first logic value.

The gate element 185 receives the output signal of the comparator and selector 181 and the output signal of the counter 183. When the output signal of the counter 183 is a second logic value, i.e., the counter 183 does not perform counting, the gate element 185 outputs a signal equal to the output signal of the comparator and selector 181 as the selection signal SEL. When the output signals of the first to mth power detectors 171 to 17m are changed and thus the output signal of the comparator and selector 181 is changed, the gate element 185 outputs a signal equal to the changed output signal of the comparator and selector 181 as the selection signal SEL.

When the output signal of the counter 183 is the first logic value, i.e., the counter 183 performs counting, the gate element 185 maintains the selection signal SEL outputted although the output signal of the comparator and selector 181 is changed.

For example, the output signal of the counter 183 may be the second logic value, and the output signal of the comparator and selector 181 may be a first signal. In this case, the gate element 185 outputs a signal equal to the first signal as the selection signal SEL. The output signals of the first to mth power detectors 171 to 17m are changed, and thus the output signal of the comparator and selector 181 may be changed from the first signal to the second signal. In this case, the gate element 185 outputs a signal, which is the same as the second signal outputted from the comparator and selector 181, as the selection signal SEL.

The beam direction fixing time information BF may be received, and thus the counter 183 may perform counting. In this case, the counter 183 outputs the first logic value. In response to the first logic value outputted from the counter 183, the gate element 185 maintains the selection signal SEL outputted. That is, the gate element 185 outputs a signal equal to the second signal as the selection signal SEL.

The output signals of the first to mth power detectors 171 to 17m are changed, and thus the output signal of the comparator and selector 181 may be changed from the second signal to a third signal. Since the output of the counter 183 is the first logic value, the gate element 185 maintains the selection signal SEL outputted even when the output signal of the comparator and selector 181 is changed. That is, the gate element 185 outputs the same signal as the second signal.

When counting by the counter 183 is ended, the counter 183 may output the second logic value. Since the third signal is outputted from the comparator and selector 181 and the second logic value is outputted from the counter 183, the gate element 185 outputs a signal, which is the same as the third signal outputted from the comparator and selector 181, as the selection signal SEL.

As described above, it can be understood that the gate element 185 perform an AND operation on the output signal of the comparator and selector 181 and the output signal of the counter 183. For example, the gate element 185 may be included in the comparator and selector 185. In this case, the output of the counter 183 may be delivered to the comparator and selector 181. The gate element 185 may be implemented in software.

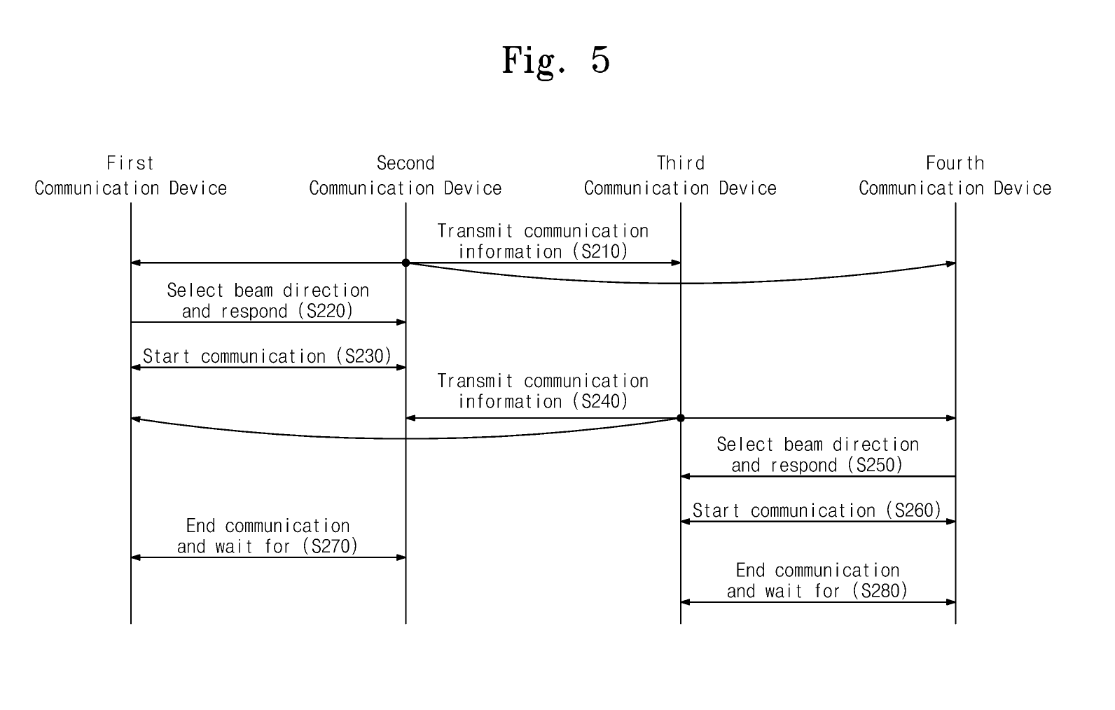

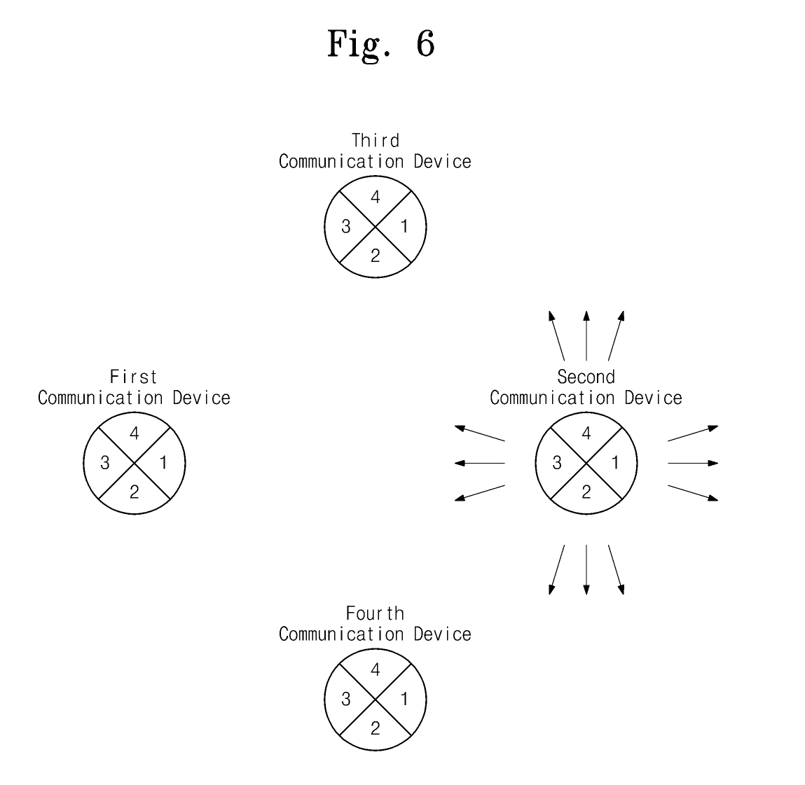

FIG. 5 is a flowchart illustrating a communication method between first to fourth communication devices. FIGS. 6 to 11 are views illustrating the first to fourth communication devices. For example, the first to fourth communications are oriented in first to fourth beam directions 1 to 4, respectively. Except that the first to fourth communications are oriented in first to fourth beam directions 1 to 4, each of the first to fourth communication devices may have the same structure and operation as those of the communication device 100 that has been described above with reference to FIGS. 1 to 3.

Referring to FIGS. 5 and 6, a transmission data may be provided to a signal processing unit of the second communication device in operation S210. The second communication device may acquire/calculate an expected communication time from the transmission data. For example, when the transmission data includes the expected communication time, the second communication device may acquire the expected communication time from the transmission data. When the transmission data does not include the expected communication time, the second communication device may calculate the expected communication time on the basis of the amount of transmission data.

When the transmission data is provided, the second communication device transmits communication information. The communication information may include an RTS, a signal, a beacon signal, a data packet, and a data frame. The communication information may include the acquired/calculated expected communication time. The communication information may include an address or identifier (ID) of a target communication device. For example, when a communication channel is not established, the second communication device may transmit a signal in a forward direction by using the first to fourth beam directions 1 to 4.

The first, third and fourth communication devices receive the communication information transmitted from the second communication device. When the communication information is received, a beam direction may be selected according to which beam direction the highest power of the communication information is received in. Exemplarily, a third beam direction 3 of the first communication device is arranged to face a first beam direction 1 of the second communication device. In the first communication device, the highest power of communication information may be received in the third beam direction 3. In the first communication device, therefore, the third beam direction may be selected and connected to a signal processing unit.

A second beam direction 2 of the third communication device faces the first beam direction 1 of the second communication device, and a third beam direction 3 of the third communication device is arranged to face a fourth beam direction 4 of the second communication device. In the third communication device, therefore, one of the second and third beam directions 2 and 3 may be selected and connected to a signal processing unit.

A fourth beam direction 4 of the fourth communication device faces the first beam direction 1 of the second communication device, and a third beam direction 3 of the fourth communication device is arranged to face the second beam direction 2 of the second communication device. In the fourth communication device, therefore, one of the third and fourth beam directions 3 and 4 may be selected and connected to a signal processing unit.

The signal processing units of the first, third and fourth communication devices demodulate received communication information, respectively. An address or ID of a target communication device may be acquired from the demodulated communication information. Communication devices that do not correspond to the acquired address or ID of the target communication device may ignore the received communication information. A communication device corresponding to the acquired address or ID of the target communication device may operate on the basis of the received communication information. For example, when the first communication device is the target communication device, the first communication device may select the first beam direction 1. At this point, the third and fourth communication devices may ignore the communication information received from the first communication device.

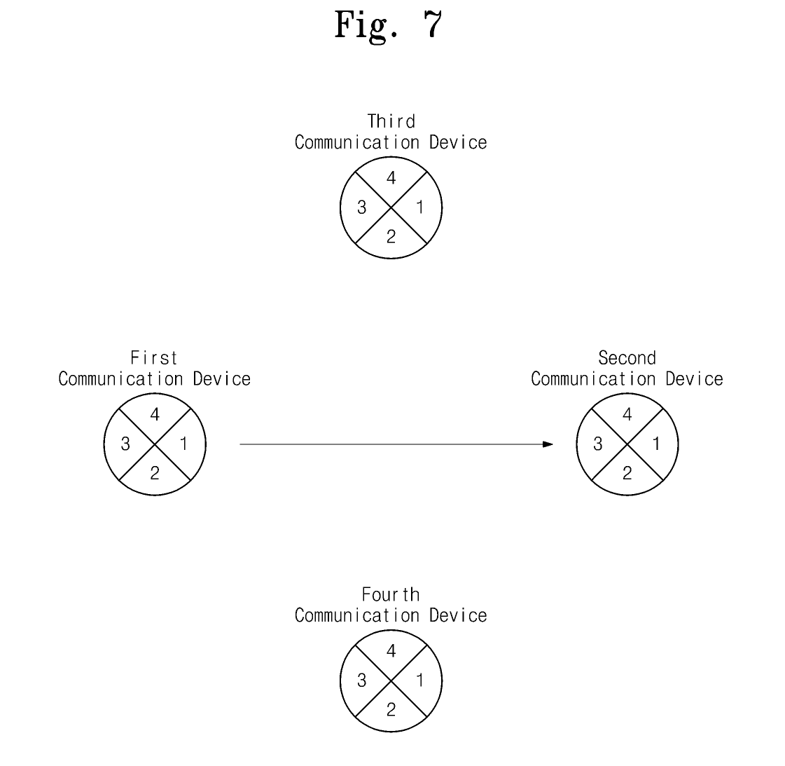

Referring to FIGS. 5 and 7, in operation S220, the first communication device may transmit a response signal to the second communication device in a selected beam direction. The response signal may a CTS signal or an acknowledge (ACK) signal. The response signal may be one of communication information.

The first communication device may acquire/calculate an expected communication time from a demodulated communication information. When the demodulated communication information includes the expected communication time, the first communication device may acquire the expected communication time from the demodulated communication information. When the demodulated communication information does not include the expected communication time, the first communication device may calculate the expected communication time with the amount of transmission data included in the demodulated communication information.

With the acquired/calculated expected communication time, the signal processing unit of the first communication device may generate the beam direction fixing time information BF. The beam direction fixing time information BF may include the expected communication time. That is, a counter 183 of the first communication device outputs the first logic value during the expected communication time. During the expected communication time, the first communication device maintains the selection of the first beam direction 1 even when signals are respectively received in the unselected second to fourth beam directions 2 to 4 of the first communication device.

When a response message is received from the first communication device, the second communication device may select a beam direction. For example, a beam direction where the highest power of the response message is received may be selected from among the first to fourth directions 1 to 4. Exemplarily, the second communication device may select the third beam direction 3.

When a response message is received from the first communication device, the second communication device may generate beam direction fixing time information BF with an acquired/calculated expected communication time. The beam direction fixing time information BF may include the acquired/calculated expected communication time. The generated beam direction fixing time information BF is provided to the beam direction selection unit 150.

When the beam direction fixing time information BF is received, a counter 183 of the second communication device performs counting for a time corresponding to the beam direction fixing time information BF. That is, the counter 183 of the second communication device outputs a first logic value during the expected communication time. During the expected communication time, the second communication device maintains the selection of the third beam direction 3 even when signals are received in unselected first, second and fourth beam directions 1, 2 and 4 of the second communication device.

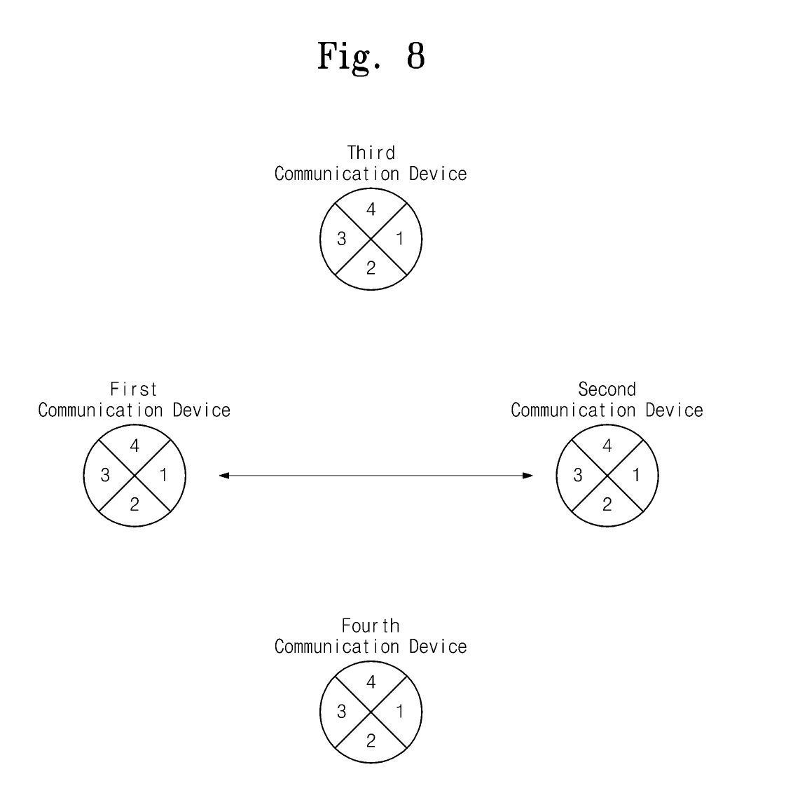

Referring to FIGS. 5 and 8, during an expected communication time, the first communication device maintains the selection of the first beam direction 1, and the second communication device maintains the selection of the third beam direction 3. The first and third communication devices start communications in the first and third beam directions 1 and 3, respectively.

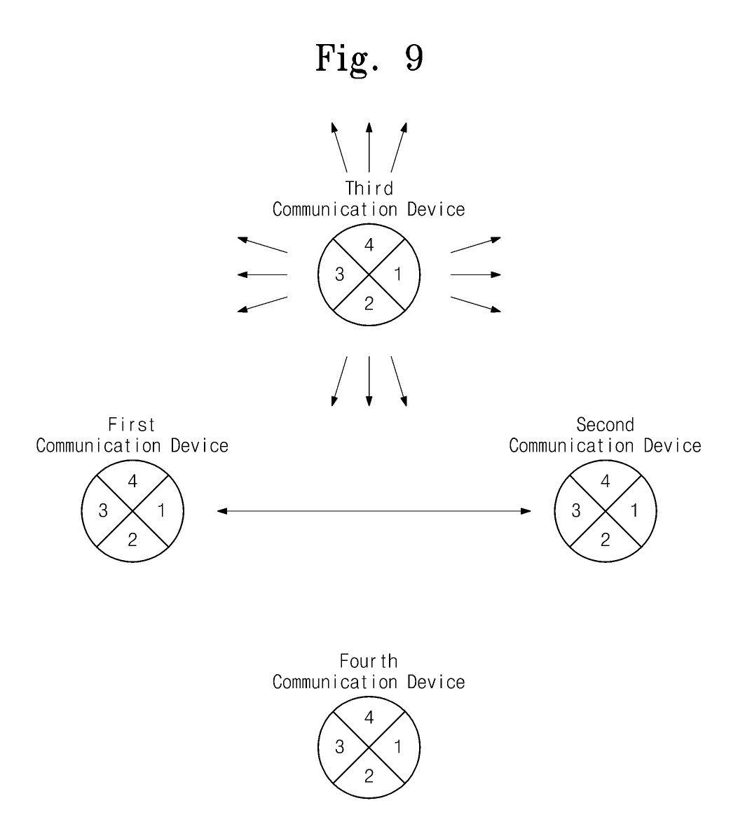

Referring to FIGS. 5 and 9, in operation S240, a transmission data may be provided to the signal processing unit of the third communication device. The third communication device may acquire/calculate an expected communication time from the transmission data. When the transmission data includes the expected communication time, the third communication device may acquire the expected communication time from the transmission data. When the transmission data does not include the expected communication time, the third communication device may calculate the expected communication time based on the amount of transmission data.

When the transmission data is provided, the third communication device transmits communication information. The communication information may include an RTS signal, a beacon signal, a data packet, and a data frame. The communication information may include the acquired/calculated expected communication time. The communication information may include an address or ID of a target communication device. For example, when a communication channel is not established, the third communication device may transmit a signal in a forward direction by using the first to fourth beam directions 1 to 4.

The first, second and fourth communication devices receive the communication information transmitted from the third communication device. In the first and second communication devices, the counters 183 are activated according to the beam direction fixing time information BF.

Even when the communication information is received from the third communication device, the first communication device maintains the selection of the first beam direction 1 for communicating with the second communication device. A plurality of signals (for example, the communication information received from the third communication device) respectively received in the second to fourth beam directions 2 to 4 of the first communication device are not transferred to the signal processing unit or demodulated.

Even when the communication information is received from the third communication device, the second communication device maintains the selection of the third beam direction 3 for communicating with the first communication device. A plurality of signals (for example, the communication information received from the third communication device) respectively received in the first, second and fourth beam directions 1, 2 and 4 of the second communication device are not transferred to the signal processing unit or demodulated.

Even when the communication information is received from the communication device, the first communication device maintains the selection of the first beam direction 1 for communicating with the second communication device, and the second communication device maintains the selection of the third beam direction 3 for communicating with the first communication device. Accordingly, even when the third communication device transmits the communication information, the first and second can continue communication without collision.

When the communication information is received by the fourth communication device, a beam direction may be selected according to which beam direction the highest power of the communication information is received in. Exemplarily, the fourth beam direction 4 of the fourth communication device is arranged to face the second beam direction 2 of the third communication device. In the fourth communication device, the highest power of communication information may be received in the third beam direction 3. In the fourth communication device, therefore, the fourth beam direction 4 may be selected and connected to the signal processing unit.

The signal processing unit of the fourth communication device demodulates the received communication information. An address or ID of a target communication device may be acquired from the demodulated communication device. For example, the fourth communication device may be the target communication device.

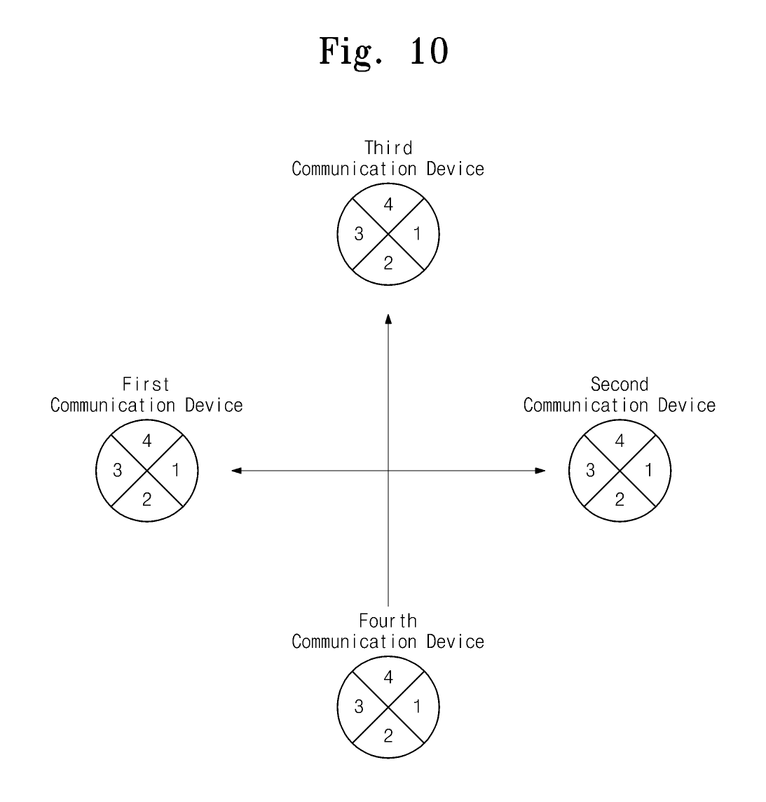

Referring to FIGS. 5 and 10, in operation S250, the fourth communication device may transmit a response signal to the third communication device in a selected beam direction. The response signal may a CTS signal or an ACK signal. The response signal may be one of communication information.

Even when the response signal of the fourth communication device is received, the first and second communication devices may maintain the selected beam direction in response to the beam direction fixing time information BF. That is, even when the fourth communication device transmits the response signal, the first and second communication devices may continue communication without collision.

The fourth communication device may acquire/calculate an expected communication time from a demodulated communication information. When the demodulated communication information includes the expected communication time, the fourth communication device may acquire the expected communication time from the demodulated communication information. When the demodulated communication information does not include the expected communication time, the fourth communication device may calculate the expected communication time with the amount of transmission data included in the demodulated communication information.

With the acquired/calculated expected communication time, the signal processing unit of the fourth communication device may generate beam direction fixing time information BF. The beam direction fixing time information BF may include the expected communication time. That is, a counter 183 of the fourth communication device outputs a first logic value during the expected communication time. During the expected communication time, the fourth communication device maintains the selection of the fourth beam direction 4 even when signals are respectively received in the unselected first to third beam directions 1 to 3 of the fourth communication device.

When a response message is received from the fourth communication device, the third communication device may select a beam direction. For example, a beam direction where the highest power of the response message is received may be selected from among the first to fourth directions 1 to 4. Exemplarily, the third communication device may select the second beam direction 2.

When a response message is received from the fourth communication device, the third communication device may generate beam direction fixing time information BF with an acquired/calculated expected communication time. The beam direction fixing time information BF may include the acquired/calculated expected communication time. The generated beam direction fixing time information BF is provided to the beam direction selection unit 150.

When the beam direction fixing time information BF is received, the counter 183 of the second communication device performs counting for a time corresponding to the beam direction fixing time information BF. That is, the counter 183 of the third communication device outputs a first logic value during the expected communication time. During the expected communication time, the third communication device maintains the selection of the second beam direction 2 even when signals are received in unselected first, third and fourth beam directions 1, 3 and 4 of the third communication device.

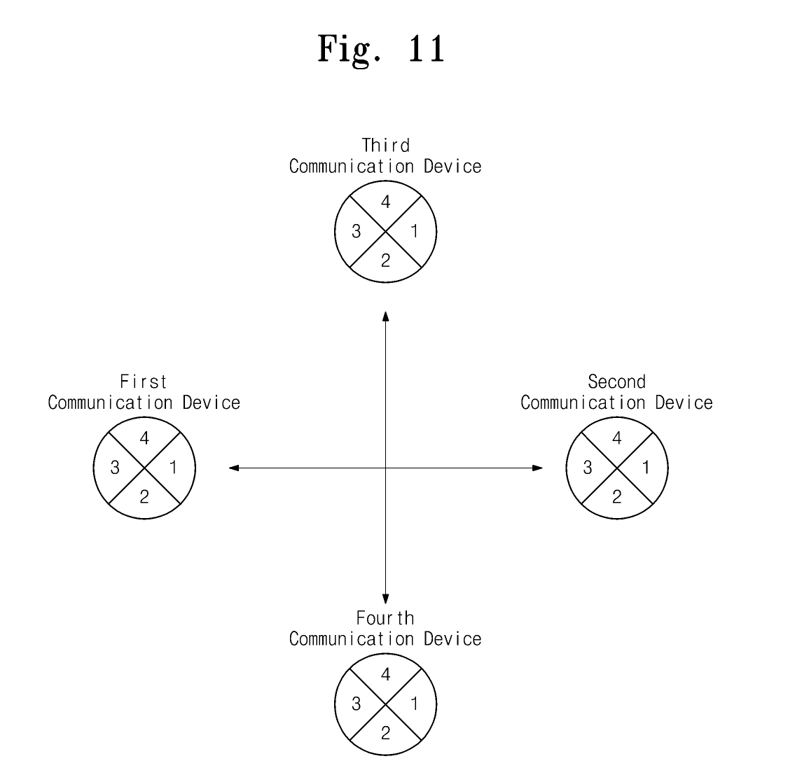

Referring to FIGS. 5 and 11, during an expected communication time, the third communication device maintains the selection of the second beam direction 1, and the fourth communication device maintains the selection of the fourth beam direction 4. In operation S260, the third and fourth communication devices start communications in the second and fourth beam directions 2 and 4, respectively.

The expected communication time of the first and second communication devices elapses in operation S270, and thereafter, communication is ended between the first and second communication devices. When the expected communication time elapses, the first and second communication devices reset the counters 183. The first and second communication devices enter into a communication standby state.

The expected communication time of the third and fourth communication devices elapses in operation S280, and thereafter, communication is ended between the third and fourth communication devices. When the expected communication time elapses, the third and fourth communication devices reset the counters 183. The third and fourth communication devices enter into a communication standby state.

As described above, the first to fourth communication devices are disposed at one hop distance apart. That is, when one of the first to fourth communication devices transmits a signal, all the other communication devices may receive the transmitted signal. According to embodiments of the present invention, between a plurality of communication devices at one hop distance, two or more communication channels may be formed without collision. Accordingly, provided are a communication device and method with enhanced reliability and frequency reuse rate.

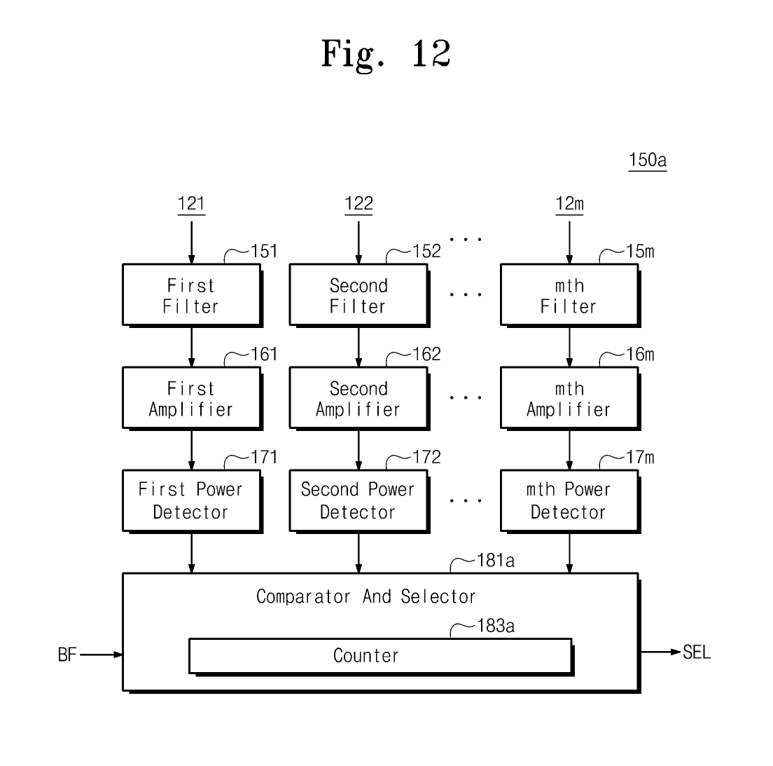

FIG. 12 is a block diagram illustrating a beam direction selection unit 150a according to another embodiment of the present invention.

Referring to FIG. 12, the beam direction selection unit 150a includes first to mth filters 151 to 15m, first to mth amplifiers 161 to 16m, first to mth power detectors 171 to 17m, and a comparator and selector 181a.

Each of the first to mth filters 151 to 15m has the same structure as that of each of the first to mth filters 151 to 15m that have been above with reference to FIG. 3. Each of the first to mth amplifiers 161 to 16m has the same structure as that of each of the first to mth amplifiers 161 to 16m that have been above with reference to FIG. 3. Each of the first to mth power detectors 171 to 17m has the same structure as that of each of the first to mth power detectors 171 to 17m that have been above with reference to FIG. 3. Therefore, detailed descriptions will not be provided.

The comparator and selector 181a receives the output signals of the first to mth power detectors 171 to 17m. The comparator and selector 181a receives the beam direction fixing time information BF from the signal processing unit 140 (see FIG. 1).

The comparator and selector 181a includes a counter 183a. When the beam direction fixing time information BF is received, the counter 183a performs counting for a time corresponding to the received beam direction fixing time information BF. That is, the counter 183a may perform counting for an expected communication time.

When the counter 183a does not perform counting, the comparator and selector 181a outputs a selection signal SEL that allows an output signal having the highest power greater than the reference value to be selected from among the output signals of the first to mth power detectors 171 to 17m. When the counter 183a performs counting, the comparator and selector 181 maintains the selection signal SEL outputted although the output signals of the first to mth power detectors 171 to 17m are changed. That is, the functions of the comparator and selector 181, counter 183 and gate element 185 of FIG. 3 can be understood as included in the comparator and selector 181a.

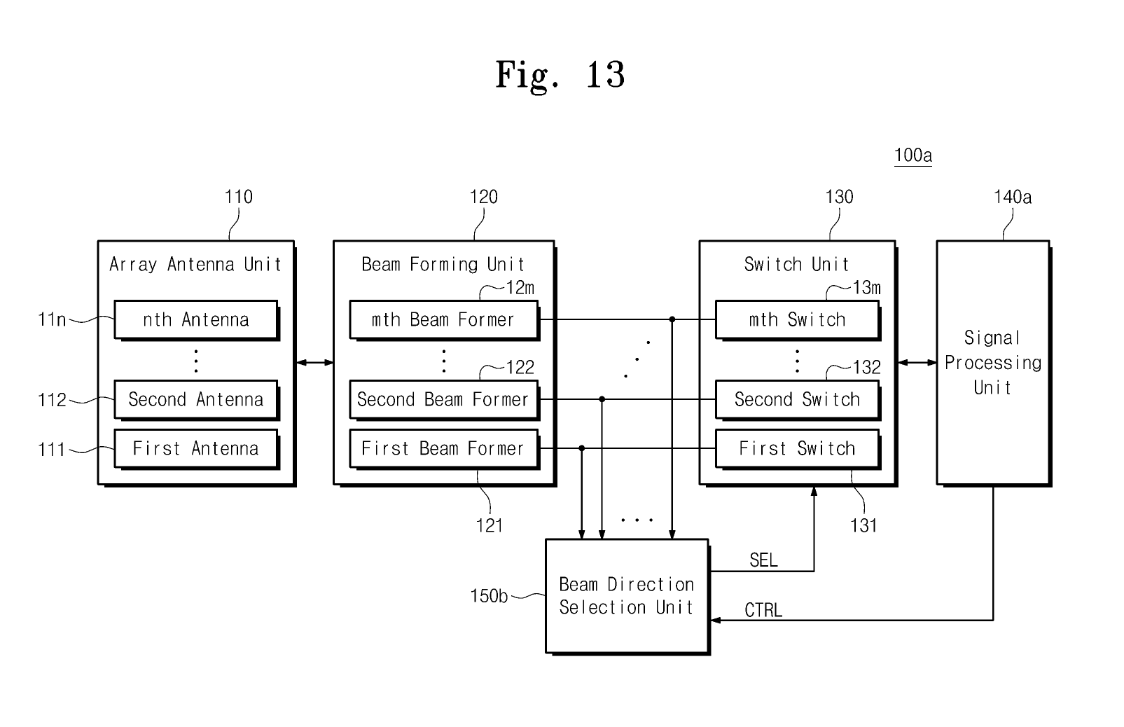

FIG. 13 is a block diagram illustrating a communication device 100a according to a second embodiment of the present invention.

Referring to FIG. 13, the communication device 100a includes an array antenna unit 110, a beam forming unit 120, a switch unit 130, a signal processing unit 140a, and a beam direction selection unit 150b.

Except for the signal processing unit 140a and the beam direction selection unit 150b, the communication device 100a has the same structure and operation as those of the communication device that has been described above with reference to FIG. 1, and thus, repetitive description will not be provided.

The signal processing unit 140a receives one of the output signals of the first to mth beam formers 121 to 12m through the switch unit 130. The signal processing unit 140a demodulates the received output signal. The signal processing unit 140a generates a control signal CTRL according to the demodulated result. For example, when the demodulated signal is for the communication device 100, the signal processing unit 140a may generate the control signal CTRL. The control signal CTRL may be delivered to the beam direction selection unit 150b.

The signal processing unit 140a modulates a transmission data. Based on the transmission data, the signal processing unit 140a generates the control signal CTRL. The control signal CTRL may be delivered to the beam direction selection unit 150b.

The signal processing unit 140a may include a modem, an MAC, or the modem and the MAC.

The beam direction selection unit 150b receives the output signals of the first to mth beam formers 121 to 12m, and receives the control signal CTRL from the signal processing unit 140a. Based on the output signals of the first to mth beam formers 121 to 12m and the control signal CTRL, the beam direction selection unit 150b generates the selection signal SEL.

Exemplarily, when the control signal CTRL is in an inactive state, the beam direction selection unit 150b may generate the selection signal SEL that allows an output signal having the highest power greater than a reference value to be selected from among the output signals of the first to mth beam formers 121 to 12m, in a communication standby state. In this case, the highest power greater than the reference value among the output signals of the first to mth beam formers 121 to 12m may be delivered to the signal processing unit 140a through the switch unit 130.

When the control signal CTRL is in an active state, the beam direction selection unit 150b may maintain the selection signal SEL even when the output signals of the first to mth beam formers 121 to 12m are changed.

For example, when the signal processing unit 140a performs modulation and demodulation, the control signal CTRL may be activated. When the signal processing unit 140a does not perform modulation and demodulation, the control signal CTRL may be deactivated. That is, the selection of a beam direction by the communication device 100a may be maintained while communication is being performed.

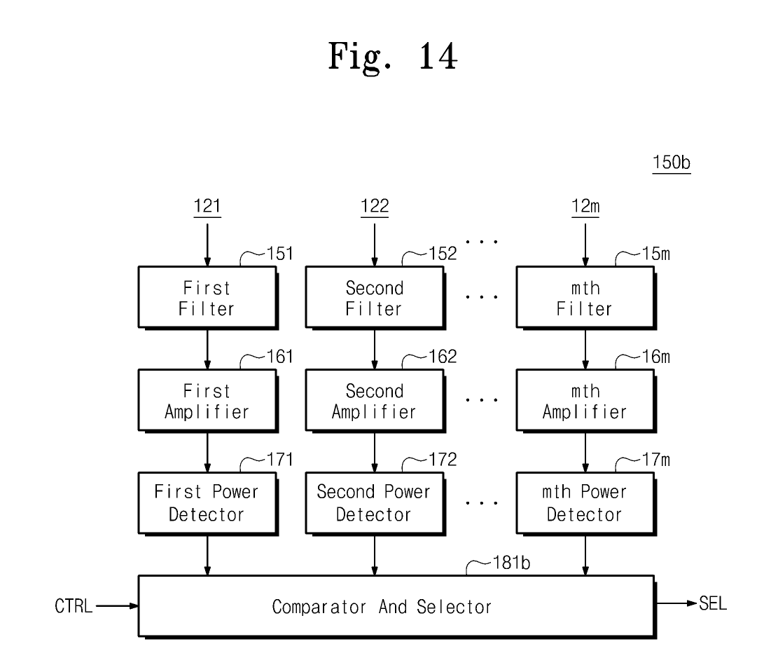

FIG. 14 is a block diagram illustrating the beam direction selection unit 150b of FIG. 13.

Referring to FIG. 14, the beam direction selection unit 150b includes first to mth filters 151 to 15m, first to mth amplifiers 161 to 16m, first to mth power detectors 171 to 17m, and a comparator and selector 181b.

Each of the first to mth filters 151 to 15m has the same structure as that of each of the first to mth filters 151 to 15m that have been above with reference to FIG. 3. Each of the first to mth amplifiers 161 to 16m has the same structure as that of each of the first to mth amplifiers 161 to 16m that have been above with reference to FIG. 3. Each of the first to mth power detectors 171 to 17m has the same structure as that of each of the first to mth power detectors 171 to 17m that have been above with reference to FIG. 3. Therefore, detailed descriptions will not be provided.

The comparator and selector 181b receives the output signals of the first to mth power detectors 171 to 17m. The comparator and selector 181b receives a control signal CTRL from the signal processing unit 140a.

When the control signal CTRL is in an inactive state, the comparator and selector 181b outputs a selection signal SEL that allows an output signal having the highest power greater than the reference value to be selected from among the output signals of the first to mth power detectors 171 to 17m. When the control signal CTRL is in an active state, the comparator and selector 181b maintains the selection signal SEL outputted although the output signals of the first to mth power detectors 171 to 17m are changed.

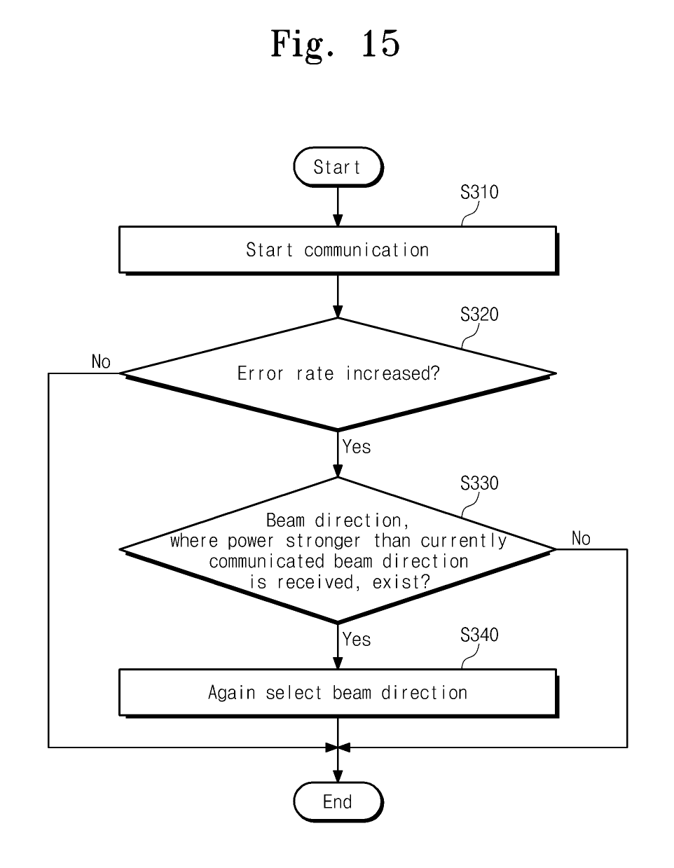

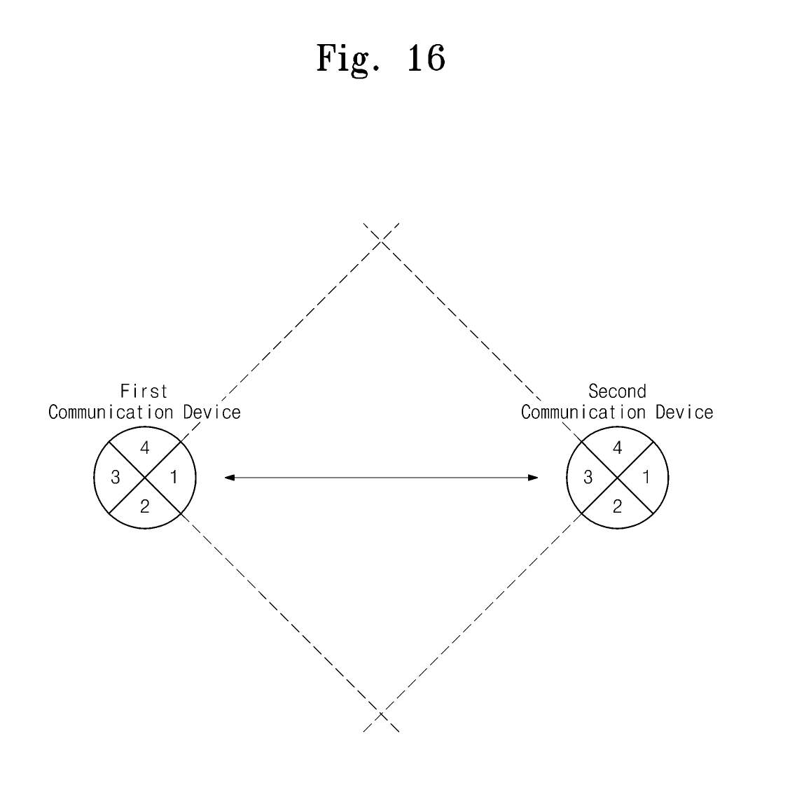

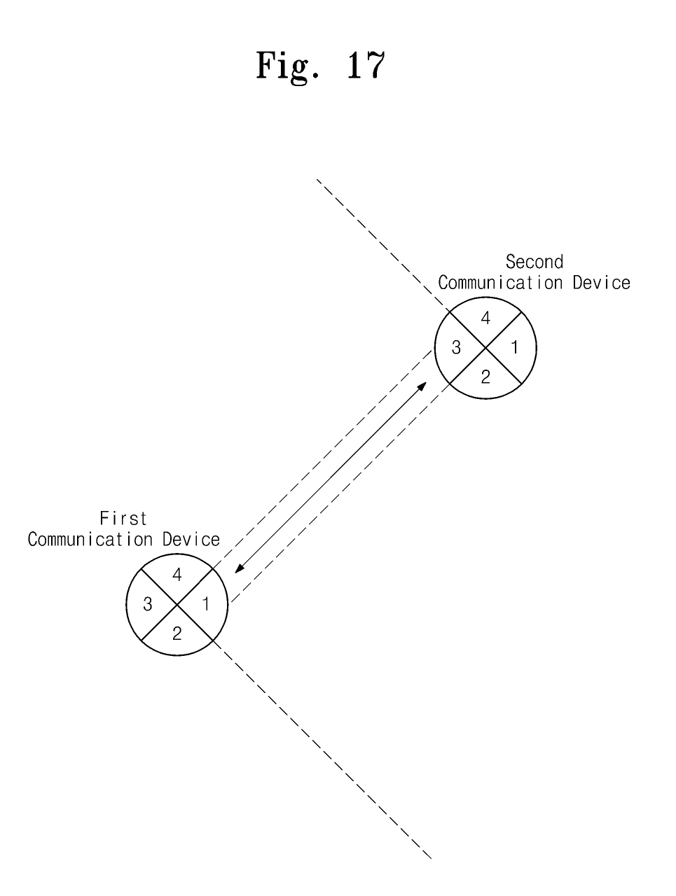

FIG. 15 is a flowchart illustrating a method of changing a selected beam direction when the first and second communication devices move. FIGS. 16 and 17 are views illustrating moving first and second communication devices.

Referring to FIGS. 15 and 16, in operation S310, the first and second communication devices start communication. For example, the first communication device may perform communication in the first beam direction 1, and the second communication device may perform communication in the third beam direction 3.

Subsequently, as illustrated in FIG. 17, the second communication device may move. As the second communication device moves, the area where the first beam direction 1 of the first communication device faces the third beam direction 3 of the second communication device is reduced. That is, a power of a signal that the first communication device receives from the second communication device can be reduced, and moreover, a power of a signal that the second communication device receives from the first communication device can be reduced. As a power decreases, an error rate of data communicated between the first and second communication devices may increase.

Referring to FIGS. 15 and 17, in operation S320, whether an error rate increases is determined. For example, whether the error rate of communicated data increases and reaches a reference value may be determined. The reference value may be equal to an error rate due to common noise or set higher than the error rate. When the error rate of communicated data increases, it can be understood that at least one of the first and second communication devices moves and thus a power of a received signal is decreased. When the error rate of communicated data increases, operation S330 is performed. When the error rate of communicated data is not increased, a selected beam direction may be continuously maintained.

In operation S330, whether a beam direction, in which a power stronger than a currently communicated beam direction is received, exists is determined. When the beam direction in which the power stronger than the currently communicated beam direction is received exists, a corresponding beam direction is reselected in operation S340. When the beam direction in which the power stronger than the currently communicated beam direction is received does not exist, a currently selected beam direction may be continuously maintained.

Exemplarily, as illustrated in FIGS. 16 and 17, the second communication device may move from the first beam direction 1 of the first communication device to the fourth beam direction 4. At this point, a power of a signal received in the first beam direction 1 of the first communication device may be progressively decreased, and a power of a signal received in the fourth beam direction 4 of the first communication device may be progressively increased. That is, as the second communication moves, the first communication device may reselect the fourth beam direction 4.

As the second communication moves, a power of a signal received in the third beam direction 3 of the second communication device may be progressively decreased, and a power of a signal received in the second beam direction 2 of the second communication device may be progressively increased. That is, as the second communication moves, the second communication device may reselect the second beam direction 2.

For example, when a signal received in an reselected beam direction does not correspond to a reception data, the first and second communication devices may reselect a previous beam direction. As an example, the signal received in the reselected beam direction may be a signal received from another communication device. That is, the signal received in the reselected beam direction may not be a signal succeeding an already received data. In this case, a previous beam direction may be reselected, and, communication may be restarted. For example, the second communication device may reselect the first beam direction 1, and, the second communication device may reselect the third beam direction 3.

According to embodiments of the present invention, while one beam direction has been selected and communication is being performed, communication information received in another beam direction is ignored. Since the selected beam direction is maintained while communication is being performed, adjacent communication devices can simultaneously perform communication through two or more channels without collision. Accordingly, provided are the communication devices and methods having enhanced reliability and frequency reuse rate.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wireless communication method comprising:
receiving communication information through a plurality of antennas;
generating a plurality of beam directions;
selecting one of the beam directions on the basis of the received communication information; and
performing communication using the selected beam direction,
wherein communication information received through the unselected beam directions among the beam directions are ignored.

2. The wireless communication method of claim 1, wherein the selecting of one comprises selecting a beam direction, where a highest power of the communication information is received, among the beam directions.

3. The wireless communication method of claim 1, further comprising selecting another beam direction from among the beam directions to perform communication in the other selected beam direction, when an error rate of data communicated in the selected beam direction becomes higher than a reference value.

4. The wireless communication method of claim 3, wherein a beam direction where a highest power of data is received is selected from among the beam directions when the error rate of the data communicated in the selected beam direction becomes higher than the reference value.

5. A wireless communication device comprising:
a plurality of antennas;
a plurality of beam formers connected to the antennas, respectively;
a plurality of switches connected to the beam formers, respectively;
a signal processing unit modulating and demodulating an output signal of one of the switches; and
a beam direction selection unit controlling the switches for a first output signal, having a highest power among output signals of the beam formers, to be delivered to the signal processing unit, in a communication standby state,
wherein the beam direction selection unit maintains a control state of each of the switches even when the output signals of the beam formers are changed, in a state where communication is being performed.

6. The wireless communication device of claim 5, wherein the signal processing unit demodulates the first output signal, determines a target address with the demodulated signal, and resets the beam direction selection unit to the communication standby state when the determined target address differs from an address of the communication device.

7. The wireless communication device of claim 5, wherein the signal processing unit demodulates the first output signal, determines a target address with the demodulated signal, and provides a beam direction fixing time information, indicating a time when the control states of the switches are maintained, to the beam direction selection unit when the determined target address is the same as an address of the communication device.

8. The wireless communication device of claim 7, wherein the signal processing unit acquires or calculates expected communication time information from the communication information, and generates the beam direction fixing time information on the basis of the expected communication time information.

9. The wireless communication device of claim 7, wherein the signal processing unit acquires or calculates expected communication time information from data to be transmitted, and generates the beam direction fixing time information on the basis of the expected communication time information.

10. The wireless communication device of claim 7, wherein the beam direction selection unit comprises:
a plurality of band-pass filters connected to the beam formers, respectively;
a plurality of amplifiers connected to the band-pass filters, respectively;
a plurality of power detectors connected to the amplifiers, respectively;
a comparator and selector generating a first signal which allows an output signal, having a highest power greater than a reference value, to be selected from among output signals of the power detectors;
a counter performing counting during a time corresponding to the beam direction fixing time information, wherein the counter outputs a first logic value when the counting is performed, or outputs a second logic value when the counting is not performed; and
a gate element outputting the same signal as the first signal when an output of the counter is the second logic value.

11. The wireless communication device of claim 10, wherein when the output of the counter is the first logic value, the gate element maintains a constant output signal despite a change in the first signal.

12. The wireless communication device of claim 7, wherein the beam direction selection unit comprises:
a plurality of band-pass filters connected to the beam formers, respectively;
a plurality of amplifiers connected to the band-pass filters, respectively;
a plurality of power detectors connected to the amplifiers, respectively; and
a comparator and selector performing counting during a time corresponding to the beam direction fixing time information,
wherein the comparator and selector outputs a signal which allows an output signal, having a highest power greater than a reference value, to be selected from among output signals of the power detectors when the counting is not performed.

13. The wireless communication device of claim 12, wherein when the counting is performed, the comparator and selector maintains a constant output signal despite a change in the output signals of the power detectors.

14. The wireless communication device of claim 5, wherein:
when communication is performed, the signal processing unit activates a control signal provided to the beam direction selection unit, and
when communication is not performed, the signal processing unit deactivates the control signal.

15. The wireless communication device of claim 14, wherein the beam direction selection unit comprises:
a plurality of band-pass filters connected to the beam formers, respectively;
a plurality of amplifiers connected to the band-pass filters, respectively;
a plurality of power detectors connected to the amplifiers, respectively; and
a comparator and selector outputting a signal which allows an output signal, having a highest power greater than a reference value, to be selected from among output signals of the power detectors when the control signal is deactivated.

16. The wireless communication device of claim 15, wherein when the control signal is activated, the comparator and selector maintains a constant output signal despite a change in the output signals of the power detectors.

17. The wireless communication device of claim 5, wherein when an error rate of communicated data becomes higher than a reference value, the signal processing unit controls the beam direction selection unit for an output signal having a highest power to be reselected from among output signals of the beam formers.

18. The wireless communication device of claim 17, wherein when the reselected output signal does not correspond to a reception data, the signal processing unit controls the beam direction selection unit for the first output signal to be selected.
